(19) United States
(12) Patent Application Publication
(10) Pub. No.: US 2020/0392831 A1
(43) Pub. Date: Dec. 17, 2020

(54) VIRTUAL LIFE METER FOR FRACKING EQUIPMENT

(71) Applicant: Halliburton Energy Services, Inc., Houston, TX (US)

(72) Inventors: Yanyan Wu, Houston, TX (US); Daili Zhang, Humble, TX (US); Manjot Singh Sohal, Houston, TX (US); Carl Manuse, Spring, TX (US); Winfred Trent Sedberry, Spring, TX (US)

(21) Appl. No.: 16/438,346

(22) Filed: Jun. 11, 2019

(51) Int. Cl. E21B 47/00; E21B 47/12; G06N 20/00

(52) U.S. Cl. CPC E21B 47/0007; G06N 20/00; E21B 47/122

(57) ABSTRACT

A virtual life meter can track the operational status of equipment used in the oil and gas industry. Historical characteristics corresponding to usage of one or more fracking devices may be received. A feature set can be generated for each fracking device using the historical characteristics. The feature sets can be used to train a machine-learning model training. Once trained, operational characteristics for fracking devices may be received and processed using the trained machine-learning model. The machine-learning model can be used to generate service objects for the fracking devices using the operational characteristics. The service objects provide an indication of an amount of time operational life remaining for each fracking device. Upon receiving a request for operational characteristics for a particular fracking device, the corresponding service object associated with the particular fracking device can be transmitted.

### TECHNICAL FIELD

The present disclosure relates generally to hydrocarbon extraction operations. More particularly, the present disclosure relates to a virtual life meter for fracking equipment.

### BACKGROUND

Oil and gas equipment, including fracking, drilling, and well extraction equipment, experience high levels of wear-and-tear during routine operations. Often the equipment is maintained in the field between operations to avoid equipment downtime or equipment failure. In many instances, the equipment may be maintained using maintenance schedules that are based on the age of the equipment rather than the stress of the operating conditions or frequency of use and provide a one-size-fits-all approach to maintaining equipment. Maintenance schedules often do not account for the particular conditions under which different equipment may be utilized. As a result, one-size-fits-all maintenance schedules either direct premature replacement of equipment or components thereof or fail to prevent equipment or component failure.

### BRIEF DESCRIPTION OF THE DRAWINGS

FIG. 1 is a block diagram of fracking devices used in fracking operations according to one aspect of the disclosure.

FIG. 2 is a block diagram of virtual life meter system according to some aspects of the disclosure.

FIG. 3 is a block diagram of a virtual life meter according to one aspect of the disclosure.

FIG. 4 is a graphical user interface representation of an amount of operational life remaining in fracking devices according one aspect of the present disclosure.

FIG. 5 is a graphical user interface representation of an amount of operational life remaining in fracking devices according one aspect of the present disclosure.

FIG. 6 is a flowchart of a process for a determining an amount of operational life remaining in fracking devices according to one aspect of the present disclosure.

FIG. 7 is a flowchart of a process for maintaining fracking devices in the field using a trained machine-learning model according to one aspect of the present disclosure.

### DETAILED DESCRIPTION

Certain aspects and features relate to virtual life meter systems that track an amount of operational life remaining in hydraulic fracturing equipment. Different fracking equipment can be subject to different types of wear and tear causing some fracking devices to require more or complex maintenance and other equipment to be replaced more frequently. A virtual life meter can be generated for each device or components thereof that are used in hydraulic fracturing operations. The virtual life meter can identify an amount of operational life remaining for the fracking devices or components thereof. The virtual life meter uses trained machine-learning models to analyze real-time operating characteristics of fracking devices operating in the field. The machine-learning models dynamically update the virtual life of devices based on the real-time operating characteristics. Based on the virtual life of the devices, maintenance schedules can be defined for the devices that reduce premature replacement, improve scheduling of hydraulic fracturing operations, and reduces fracking device operation downtime.

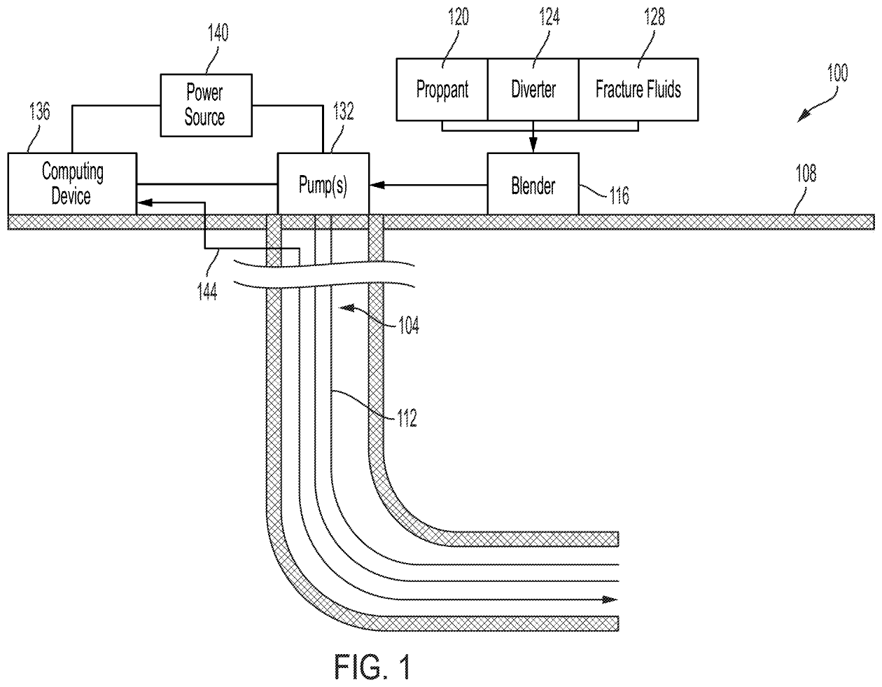

FIG. 1 is a block diagram of devices used in fracking operations 100 according to one aspect of the disclosure. Hydraulic fracturing involves executing one or more wellbore operations that can include pumping one or more materials, such as fluid, proppant, diverter, etc. into a subterranean environment to break up the subterranean environment, extracting resources, modifying the subterranean environment to control the integrity of the environment or the path of fluid, etc. In some instances, a wellbore 104 may extend perpendicular to the ground 108 at a predetermined depth. The wellbore may include tubing string 112 that extends through a at least a portion of the wellbore an enables delivery of the one or more materials from the surface to particular locations within the wellbore. The wellbore can additionally include sensors (not shown) that measure characteristics of the subterranean environment or the status of the fracking operations.

Hydraulic fracturing uses a multiple disparate types of fracking devices during operations. Fracking operations 100 may include reservoirs of materials such as fracking fluids 128, stored as individual fluids or as a blend, proppants 120, diverters 124, etc. Each material may pass through blender 116 that provides appropriate fluid or solid consistency as needed downhole. For example, blender 116 may ensure that a diverter of a specific mesh size is passed to one or more pump 132 for distribution into the subterranean environment. Blender 116 may also generate a blending fluid specific to each stage of the fracking operation. Blender 116 can include a single blender or multiple blenders, one for each material to be blended.

Blender 116 may pass the material to be pumped into the tubing string to one or more pumps 132. In some instances, a single pump may be used to pump each material into the tubing string. In other instances, a different pump may be used for each material such fluid may be pumped into the tubing string by a different pump from the pump that pumps diverter into the subterranean environment. Computing device 136 may monitor or control the fracking operations. Computing device 136 may receive communications from one or more remote devices as well as from sensors positioned on the surface of the ground 108 and in the wellbore. In some instances, computing device 136 both transmit and receive signals using cable 144. Cable 144 may be used to transmit sensor data within the subterranean environment to computing device or other remote devices. In addition, cable 144 may be used by a data acquisition system component of the computing device to generate a vertical seismic profile of the subterranean environment.

As described above, fracking operations include a variety of disparate types of fracking devices. In a best case scenario, a failure of any individual fracking device may simply cause operations to halt until a repair or replacement can be performed. Yet, in some cases, a failure may cascade, affecting other fracking devices or destroying wellbore 104. For example, if pressure in the wellb ore exceeds safety thresholds, tubing string 112 may become compromised such that the wellbore may collapse affecting the ground 108 and thereby all of the fracking devices on the surface. Even if tubing string remains intact, the excess pressure may destroy the one or more pumps 132 and sensors such as cable 144 in the subterranean environment. A virtual life meter system may be used to monitor the status of devices during hydraulic fracturing operations to identify unsafe operating conditions of the devices and to provide an indication as to an amount of operational life remaining for each device.

A virtual life meter system can include receiving operational characteristics from each fracking device during operations in the field. In some instances, the fracking device may include built in sensors that monitor various characteristics that may be unique to that device. For example, a pump may have a pressure sensor while a motor may have a sensor monitoring revolutions-per-minute instead. Some fracking devices may also include a data interface that enables access to the measurements collected by the built sensors. The data interface may enable communication via a wired or wireless connection with other external devices. In other instances, an internet-of-things (IOT) device may be attached to each fracking device. The IOT device may be generic, such that the same type of IOT device may be attached to any fracking device or specific, such that each IOT device may be specially designed to collect measurements from a particular type of fracking device. IOT devices may include a network interface to enable remote communication with a server. If the fracking device includes built-in sensors but lacks a data interface, the attached IOT device may act as a network interface for the fracking device enabling the fracking device to communicate sensor data with external devices.

In still yet other instances, some fracking devices may be modified to capture sensor measurements or to communicate sensor measurements to remote computing devices. For example, some devices may have the ability to measure characteristics of the device, but under normal operations may not do so. Electrically controlled devices may include processors and memory that execute software instructions to control the functions of the devices. Instrumentation may be embedded into the memory to cause the devices to capture measurements of characteristics of the devices. In some instances, basic input/output system (BIOS) or firmware of the device may be modified to enable the devices to capture particular measurements of characteristics of the device or to communicate with the remote device.

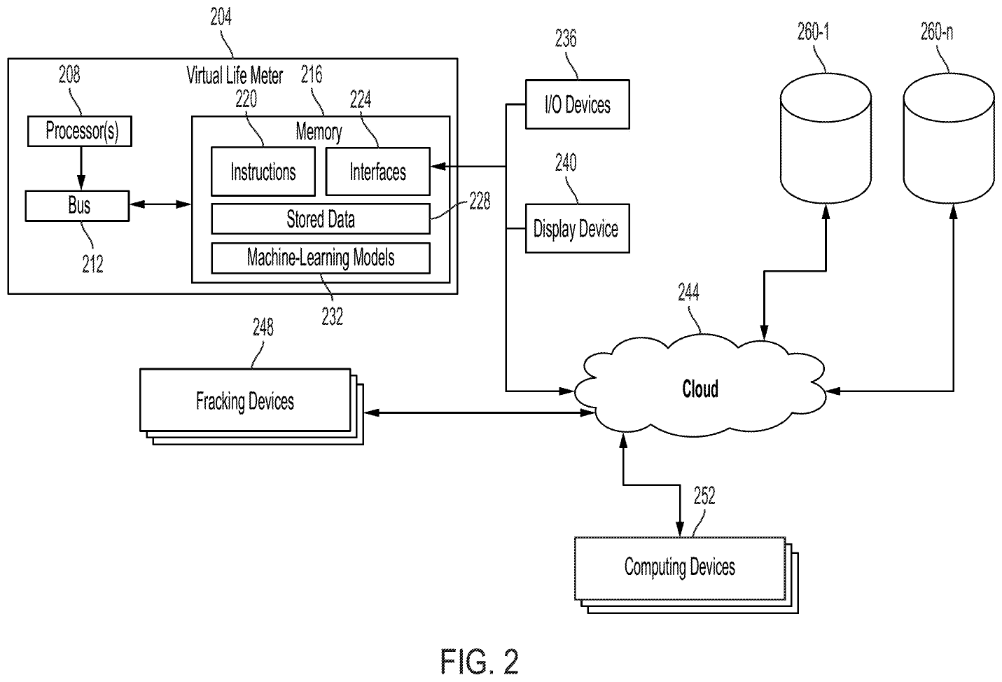

FIG. 2 is a block diagram of virtual life meter system according to some aspects of the disclosure. The virtual life meter system 200 includes a virtual life meter 204 that monitors the properties of fracking devices. In some instances, a virtual life meter 204 may execute instructions to monitor multiple fracking devices and the components of each fracking device. In other instances, multiple virtual life meters 204 may be instantiated, one for each component of a fracking device or one for each fracking device. In still yet other instances, each virtual life meter 204 may be a set of software processes that are executed on a hardware platform such as a server (not shown) or computing devices 252). A new virtual life meter may be instantiated once a new component or fracking device is added. Virtual life meters 204 may be accessed to present the status of fracking devices in use in the field throughout the entire use or lifespan of the fracking devices.

Virtual life meter 204 can include one or more processors 208 and memory 216 connected to the one or more processors via bus 212. Memory 216 can include one or more sets of instructions 220 that can be executed by the one or more processors 208 or by one or more processors of an external device (not shown). The one or more sets of instructions 220 may enable virtual life meter 204 to communicate with fracking devices deployed in the field. As used herein, a fracking device can include, but are not limited to, one or more of: fracking devices 248, drilling equipment, computing devices, electrical devices, well extraction equipment, sensors, devices used in the oil and gas industry to mine or refine oil or gas, machinery, combinations thereof, or the like. Examples of components can include any object, subsystem, or the like within a device that alone or in combination with other objects, subsystems, or the like executes a function of the device.

The one or more sets of instructions 220 may use interface 224 to obtain the status of the fracking devices or one or more current properties of the fracking devices. For example, the one or more sets of instructions 220 may use interface 224 to transmit a request to an electric motor for its status or to request operating parameters of the motor. Examples of operating parameters of a motor can include, but are not limited to, operating status such as in-operations or offline, temperature, current revolutions per minute (RPM), historical RPM, age, amount of time spent in-operation, date of last maintenance, load, input power, or the like. Each fracking device and component thereof may expose one or more values that correspond to the operation parameters specific to that fracking device or component. For example, the computing device may not include a property that is analogous to a RPM value, while the motor may not include a memory latency value. The one or more sets of instructions 220 enable the virtual life meter 204 access to the particular operating parameters of each fracking device in the field and components thereof.

In some instances, interface 224 may expose an application programming interface (API) that enables remote devices to access data and processes stored on memory 216. For example, since some remote device may not know the protocols used by the virtual life meter 204 to communicate, virtual life meter may enable a generic communication requests. In response, virtual life meter 204 may transmit the API to the external device so that the external device can programmatically access the data and processes stored on memory 216. In other instances, interface 224 may be communicate via a standardized web protocol such a web service, Internet protocol, transmission control protocol, combinations thereof, or the like. Users can interact with virtual life meter 204 through input/output devices 236 which can include physical devices, such as keyboards and mice, and virtual devices. Interface 224 may generate visual representations of virtual life meter system 200 and the data of virtual life meter 204 via one or more display devices 240.

Memory 216 may include a stored data 228 partition. Stored data 228 may include the historical status and operational characteristics of fracking devices and components associated with virtual life meter 204. In some instances, the historical status and operational characteristics may be used as training data for one or more machine-learning models 232. In other instances, the one or more sets of instructions 220 may include instructions for generating training data for machine-learning models 232. In some instances, stored data 228 may be offloaded in one or more databases 260-1-260-n. For example, the virtual life meter 204 may include multiple virtual life meters that are load balanced such that each virtual life meter may monitor one or more fracking devices in the field. Virtual life meters may share stored data 228 by storing the stored data centrally via databases 260-1-260-n. In some instances, databases 260-1-260-n may store the data used to train each machine-learning model 232 to maintain the integrity of each train machine-learning model.

Machine-learning models 232 may process incoming data from fracking devices and define a current status of each fracking device and its components and estimate an end-of-life for the fracking device and each of its components. Machine-learning models may first be trained using generated data or historical fracking devices data. Once trained, machine-learning models may be accessed by a user of virtual life meter 204 or by one or more devices such as computing devices 252. In some instances, machine-learning models may generate alerts indicating a change in the status of lifespan of particular fracking device or component. Alerts may be transmitted to an engineer operating or maintaining the fracking device or components thereof. In some instances, the alert may indicate the status change and recommend a remediation action. For example, the alert may indicate that particular component should be replaced or that the fracking device should be taken offline for testing. In some instances, machine-learning models 232 may publish the data and analyses of the data via a web service.

Virtual life meter 204, fracking devices 248, and computing devices 252 may communicate via cloud network 244. In some instances, other network types may be provided to facilitate connections between devices and fracking devices in virtual life meter system 200. Examples of other types of networks include, but are not limited to: local area networks, wide area networks, ad hoc networks, wireless networks, or the like.

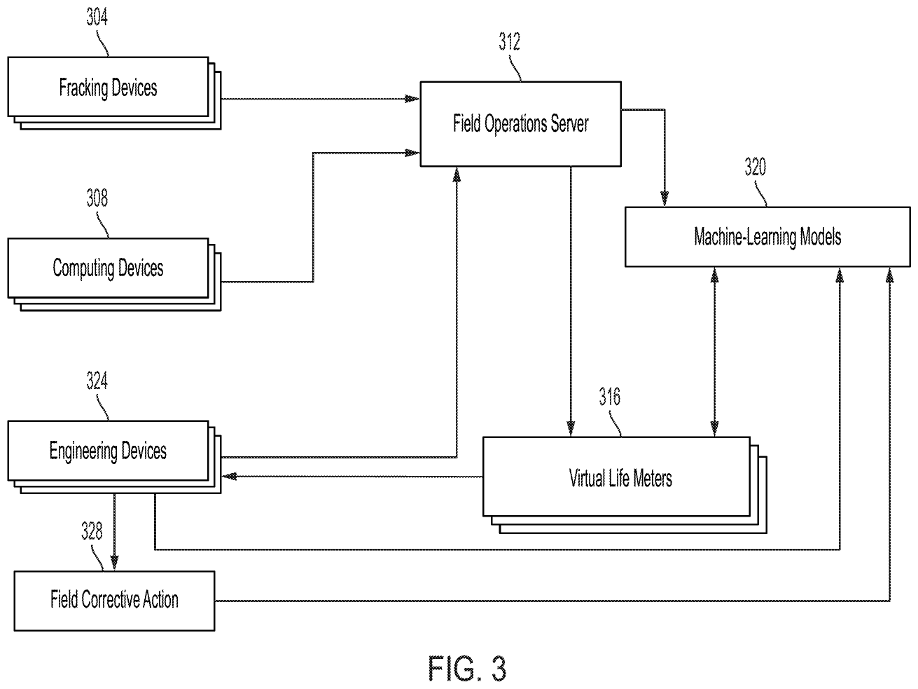

FIG. 3 is a block diagram of a virtual life meter system 300 according to one aspect of the disclosure. Virtual life meters monitor the status of fracking devices deployed in the field. For example, fracking devices 304 and computing devices 308 may continuously stream data to field operations server 312. The data may include any data generated by a respective fracking device, a sensor of the fracking device, or any data that characterizes a property of the fracking device. Examples of data can include sensor data; electrical data such as input power or consumed power; fracking device or device configuration data; data associated with a characteristic of the fracking device or device such as age, dimensions, displacement, material composition, velocity, or the like; data generated by a field-engineer operating or maintaining the device; a load, or the like.

In some instances, the data may be streamed to field operation server 312 for central storage and analysis. In other instances, field operation server 312 may transmit a request for operational characteristics to one or more fracking devices or computing devices. The receiving device may transmit the requested data to field operations server 312. The request may indicate the particular data to be transmitted to field operations server 312 or that all data is to be transmitted to field operations server 312. The data may include data collected at approximately the same time as the receipt of the request. In some instances, fracking devices 304 and computing devices 308 may retain data for a predetermined interval of time before replacing the stored data with newer data. Requests by field operations server 312 may indicate a time interval over which collected data is transmitted to field operations server 312. For example, field operations server 312 may request data collected over the last sixty minutes.

In still yet other instances, only a portion of the data may be transmitted to field operation server 312. To avoid generating status based on outdated data, a time interval may be defined for each fracking device and computing devices. Field operation server 312 may aggregate data available over the time interval and discard data that exceeds the time interval. The time interval may be a revolving window such as, for example, the last 30 days. Data may be continuously aggregated by field operation server 312, but data that exceeds time interval may be discarded in favor newer data.

One or more virtual life meters 316 may generate a current status of particular fracking devices, individual components of fracking devices, or computing devices in real-time. In some instances, virtual life meter may indicate an amount of remaining functional life for a particular fracking device, individual components of fracking devices, or computing devices. For example, virtual life meters 316 may indicate that particular drilling platform has approximately one month of functional life remaining before a failure is expected. Virtual life meters 316 may indicate a likely cause of the fracking device failure. For example, virtual life meters 316 may indicate that a pump is likely to be the point of failure for the drilling platform. Virtual life meter 316 may generate a graphical user interface representing the status of fracking devices and computing devices for display to a user.

Virtual life meters 316 may use one or more machine-learning models 320 trained to analyze historical and current data and to provide a current status of particular fracking devices. Historical data, maintenance data, and characteristic data of the fracking device and computing devices can be obtained from field operations server 312 and used to train one or more machine-learning models 320. Once trained, the machine-learning models 320 may access current data corresponding to fracking devices and computing devices to determine a status of for each computing device and fracking device in real-time. Machine-learning models 320 may use a particular subset of the data for training or real-time analysis to reduce the amount of data used in training and in status determinations. The data used for training or to determine the status of fracking devices or computing devices may be selected based on engineering devices 324 such as users in the field, data analysis of the data in field operation server 312, combinations thereof, and the like. The reduced data set may cause machine-learning models 320 to have a smaller memory footprint, which can enable machine-learning models to deploy and execute quickly to monitor fracking devices and computing devices. Once a status is defined by machine-learning models 320, the status may be communicated to virtual life meter 316, which may present the status to a user or otherwise alert the user as to the current status or a change in status.

Virtual life meters 316 may transmit alerts or status information of fracking devices 304 or computing devices 308 to engineering devices 324 in the field. Engineering devices 324 may include computing devices operated by users who operate or maintain fracking devices 304. Engineering devices 324 may receive the status or alert and generate a field corrective action plan. For example, virtual life meter 316 may generate an alert that a particular fracking device is likely to fail before the is complete. Virtual life meter 316 may additional indicate the likely cause of the failure. In some instances, engineering devices 324 may request additional information from field operations server 312 or machine-learning models 320. The additional information may include information regarding replacement fracking devices or components, likely points of failure, likely downtime as a result of the failure, likelihood that the failure may cause other fracking devices or components to fail, or the like. The field corrective action may include repair, maintaining, or replacing the fracking device.

Engineering devices 324 may determine an appropriate corrective action to implement in the field. Examples of corrective action can include taking fracking devices or computing devices offline, providing corrective maintenance on particular fracking devices or computing devices, replacing fracking devices or computing devices, generating reports, generating further data corresponding to the expected failure, or the like. The field corrective action 328 may be implemented to avoid the possible failure and prevent fracking device downtime. Data associated with the field corrective action 328 may be transmitted to machine-learning models 320. The machine-learning models 320 may be updated to reflect the corrective action and an updated status for the fracking device or computing device may be provided to virtual life meter 316.

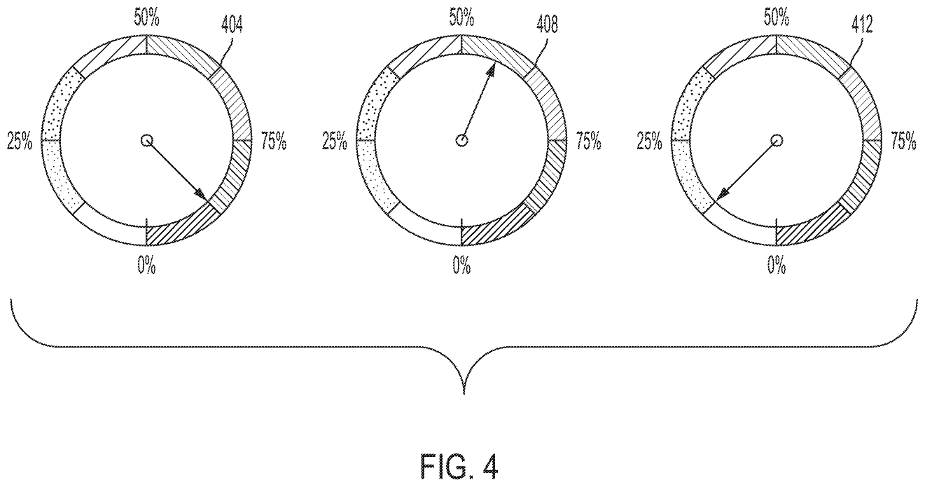

FIG. 4 depicts a graphical user interface of a virtual life meter at various stages of a fracking device life according one aspect of the disclosure. Virtual life meters may present the status of devices in alphanumeric text, graphical user interfaces such as those depicted in FIG. 3, via an output of the fracking device such as using one or more light emitting diodes, a seven-segment display, or the like, combinations thereof, or the like. The status may indicate both the current lifespan of the device as well as an expected time or failure based on current operational data. For example, a virtual life meter may indicate that a component has 60 months of operational life left and that the component has a total operational life of 120 months.

Virtual life meters may present a graphic indication as to the remaining operational life of fracking devices. Graphic 404 represents an example of a status of a fracking device or a component thereof at an initial stage of a field operations. Graphic 404 represents the status of the fracking device in terms of the percentage of remaining operational life of the fracking device. As shown in graphic 404, there is a large percentage of the fracking device's maximum operational life remaining. As use of the fracking device continues the percentage of operational life remaining in the fracking device may decrease. Graphic 408 presents the decreased percentage of operational life.

Graphic 412 depicts a status in which the fracking device has very little remaining operational life. In some instances, the virtual life meter may have a minimum status. Once the minimum status is reached or exceeded, the virtual life meter may issue an alert to a field engineer warning that failure may occur shortly. The virtual life meter may additionally indicate a component that is likely to be the cause of the failure and optionally indicate a recommended remedial action to avoid excessive fracking device downtime or job delay. For example, the recommend medial action may be particular maintenance or a replacing a particular component that is likely the cause of the expected failure.

Although the graphics 404-412 indicate a percentage of remaining operational life, and particular value that indicates an amount of remaining operational life may be used. For example, the graphic may represent an amount of operational life remaining in time such as in minutes, hours, or days. Graphics 404-412 may be static images or interactive images.

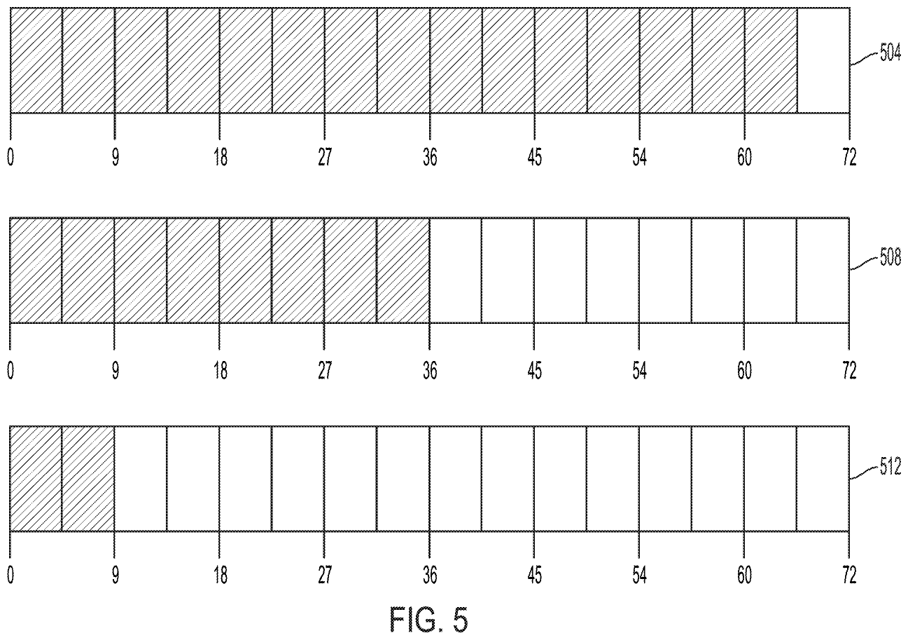

FIG. 5 depicts another graphical representation of a virtual life meter according to one aspect of the disclosure. The bar graphic indicates a number of remaining months of operational life remaining. Graphic 404 may be a representation of a fracking device soon after operations in the field have commenced. As operations continue, the remaining operational life of the fracking device may decline such as depicted in 504-508 and from 508-512. In some instances, virtual life meter may update an amount of remaining operational life based on real-time operational data that is passed through the machine-learning model. In other instances, the virtual life meter may receive a current amount of remaining operational life and count downward. In still yet other instances, the virtual life meter may receive a current amount of remaining operational life to, begin counting downward, and be periodically updated based the machine-learning model's analysis of real-time operational data.

In some instances, the virtual life meter may convey other information related the operational characteristic of fracking devices. For example, the virtual life meter may additional display a percentage usage value or intensity value for a particular characteristic of the fracking device that can be an indicator of the operating stress of the fracking device. In some instances, the overall percentage usage value or intensity value may be displayed with a particular graphic or color that may change if the percentage usage value or intensity value exceeds particular thresholds. For example, if the load of a motor exceeds a threshold amount than the overall percentage usage value or intensity value may be presented as red or in any other manner as conveying that the continued use of the motor may result in a premature failure of the motor. In some instances, an alert may be transmitted to field engineers indicating the high load and the possibility of failure induced by the high load. The alert may include a suggested remedial action. Using the above example, the remedial action can include reducing the load on the motor, placing the motor in an offline status, etc. On the other hand, if the load does not exceed the threshold than the overall percentage usage value or intensity value may be presented as green or in any other manner as conveying that the value is within acceptable operational standards.

Although FIG. 4 and FIG. 5 depict particular graphical representations of the status of fracking devices, the respective graphical representations are intended to be examples of possible graphical representations of the status of fracking devices and not the only possible graphical representations. The representation of the status of fracking devices may appear in any format that conveys the real-time status of fracking devices as a function of the remaining lifespan of the fracking device. For example, the status may be represented as an alphanumeric string, as a static graphic, as an animated graphic, combinations thereof, or the like.

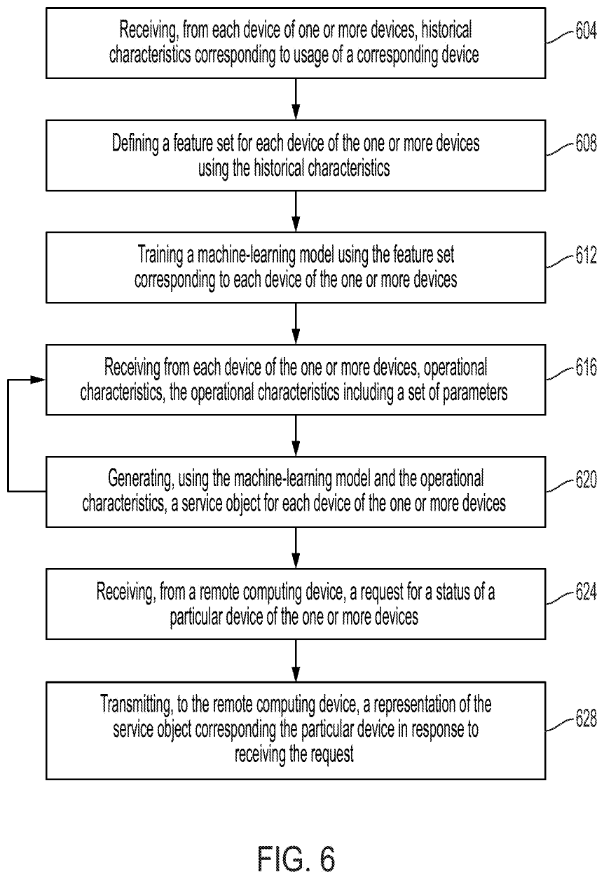

FIG. 6 is a flowchart of a process for a determining an amount of operational life remaining in fracking devices according to one aspect of the present disclosure. At block 604, historical characteristics may be received by one or more virtual life servers from fracking devices. The historical characteristics include any property the fracking device that can indicate, wholly or partially, an intensity of use of the device. Examples, of properties can include, but are not limited to: power consumption, temperature, load, revolution per minute, pressure, heat, velocity, acceleration, volumetric flow rate, efficiency, memory latency, processing latency, communication latency, communication throughput, or the like.

The historical characteristics collected and transmitted by fracking devices may correspond to the type of fracking device. For example, a motor may transmit a power consumption, a load, a revolutions per minute over a time interval, efficiency as measured by

$$\frac{mechanical power}{electircal power} ,$$

combinations thereof, or the like. On the other hand, a pump may transmit power consumption, pressure, volumetric flow rate or mass flow rate, efficiency in terms of

$$\frac{input power consumed}{output power delivered by the fluid} ,$$

combinations thereof, or the like. Each fracking device may transmit the values corresponding to each measured property. Alternatively, if a fracking device lacks remote communication capability, an IOT device may be interfaced with the fracking device. The IOT devices may collect the values or receive the values and communicate the values to the virtual life server.

The historical characteristics may be collected by fracking devices over a time interval of a predetermined duration. For example, the time interval may be a moving window in which newer historical characteristics may continuously replace older historical characteristics. In some instances, virtual life server may transmit a request for historical characteristics to particular fracking devices. The request may indicate a current time interval over which the historical characteristics are sought and optionally particular properties to include in the historical characteristics. For example, the current time interval may be a portion of the overall time interval or equal to the overall time interval. Once the request is received by particular fracking devices, the particular fracking devices may package the historical characteristics into one or more transmission to the virtual life server.

In other instances, the fracking device may continuously stream or transmit the historical characteristics to the virtual life server. For example, each device may package one or more collected proprieties into a historical characteristics package for transmission to the server. Each device may transmit the historical characteristics continuously or in set intervals, such as every 500 milliseconds or the like. The central server may store the historical characteristics in association with the fracking device that transmitted the a historical characteristics and in association with the time in which the transmission was sent or received.

At block 608 a feature set may be defined for the fracking device. A feature set may include one or more properties included in the historical characteristics of one or more fracking devices. The feature set may include only those one or more properties that are collected over a particular time interval. The feature set may additionally include external information associated with the fracking device such as, but not limited to, manufacturing date of the fracking device, frequency of use, duration of use, maintenance schedules, repaired or replaced components, date or time of repaired or replaced components, estimated or calculated failure rate of the type of fracking device, failure rate of fracking devices sharing similar characteristics or properties, actual failure of the fracking device, combinations thereof, or the like. In some instances, such as when historical characteristics are not available for particular fracking devices, the feature set may include only the external information associated with the fracking device.

In some instances, the feature set may include a portion of both the historical characteristics and the external information of the fracking device. The portion selected may be based on a likelihood that the selected historical characteristics and external information are more likely to be indicators of the remaining life of fracking devices. The particular portion of the historical characteristics or external information may be based on a type of fracking device such that different fracking devices may include different portions of the historical characteristics or external information in the respective fracking device's feature set. The portion of the historical characteristics or external information selected for inclusion into the feature set may be predetermined by, for example, an operator of the virtual life system or by the machine-learning model. For example, once trained the machine-learning model may indicate that certain properties of a device are good indicators for determining an amount of remaining life for a device while other properties are poor indicators. Future feature sets may include the good indicators while excluding the poor indictors. Alternatively, the future feature sets may retain both the good and poor indicators, but weight then accordingly. In some instances, instrumentation instructions may be modified to stop collection of the poor indicators.

At block 612, the feature set of each fracking device is used as input into one or more machine-learning models to train the models. Training the machine-learning models can include supervised or unsupervised learning. In supervised learning, the feature set can include labeled data that indicates the lifespan of historical devices using the historical characteristics and external information. For example, the feature set may indicate that fracking devices with a given set of historical characteristics and external information may have a particular amount of remaining life. In another example, the feature set may indicate that fracking devices with a given historical characteristics and external information failed at particular time or date. The machine-learning model may use the feature set, as input, and the labels, as expected output, to define one or more functions that will output an expected operational life remaining for each fracking device. The accuracy of the one or more functions, and the machine-learning model, may depend on the number of feature sets used to train the machine-learning model. Examples of algorithms that can be used for supervised learning include, but is not limited to, regression including linear and non-linear, Bayesian statistics, neural networks, decision trees, Gaussian process regression, nearest neighbor, combinations thereof, and the like.

In unsupervised learning, the feature sets may not be labeled such that the machine-learning model may not have access to the remaining life of fracking devices associated with a given feature set. Since the remaining life is unknown, the machine-learning model may use different algorithms from those used during supervised learning. Unsupervised learning may focus on identifying correlations between (1) two or more properties and (2) one or more properties and the external information. Unsupervised learning may identify one or more properties that are better indicators for determining an amount of operational life remaining then other properties. The properties may be weighted to ensure that that those properties have larger impact on determining the remaining operational life then other properties. Examples of unsupervised learning algorithms for machine-learning models include, but are not limited to, clustering, neural networks, outlier detection, combinations thereof, or the like.

The machine-learning models may be trained over a predetermined interval of time based on the size of the feature sets and the number of fracking devices included in the training data. In some instances, training may continue until predetermined threshold is met. For example, training may continue until a predetermine number of feature sets are collected. In another example, training may continue until the machine-learning model reaches a predetermined accuracy value. In some instances, accuracy may be determined by passing labeled feature sets into the machine-learning model and matching the output to the label. In other instances, accuracy may be determined based on user analysis of the training or live data or the rate at which the machine-learning model generates an output from a given input.

The machine-learning model may be continuously trained, first using the training feature sets and then using contemporaneous operational characteristics and external data to update and further improve the machine-learning model. In some instances, the machine-learning model may be discarded and a new machine-learning model may be trained using newer training data. For example, the machine-learning model may be trained using a first type of fracking device. Over time, those fracking devices may be replaced by a second type of fracking device. The second type of fracking device may have characteristics that do not corresponds to characteristics of the first type of fracking device. As a result, the trained machine-learning model not be accurate in determining the operational life remaining for the second type of fracking device.

The machine-learning model may be retrained or discarded in favor of a new machine-learning model in predefined intervals. Examples of predetermined intervals can include, but is not limited, the expiration of a predetermined time interval, such as every 30 days; receiving feature sets from a predetermined number of unknown fracking devices or from a predetermined number of fracking devices of a type that was not present in the training feature sets, detecting the accuracy of the machine-learning model falling below a predetermined value, a memory footprint of the machine-learning model exceeding a threshold amount, a time interval over which an output is generated from a given input exceeding a threshold amount, combination thereof, or the like.

At block 616, operational characteristics of one or more fracking devices may be received. The operational characteristics represent current characteristics of the fracking devices as distinguished from the historical characteristics used to train the machine-learning model. In some instances, the current characteristics are received in real-time, such as at approximately the instant the characteristics are collected or recorded by the fracking devices. In other instances, the operational characteristics may be received in predetermined intervals, such as every 100 milliseconds or the like. In still yet other instances, only changes in operational characteristics may be received. For example, a value for a property may be received once and recorded. A value for the property may not be received again until the new value differs from the previously recorded value. This may advantageously reduce network congestion when a large number of fracking devices are transmitting operational characteristics.

The operational characteristics may include values for the same set of properties as the historical characteristics for a given fracking device type. For example, the historical characteristics may include historical values for properties such as revolutions-per-minute, load, and input power. The operational characteristics for a similar motor, or the same exact motor, may include contemporaneous values for the same set of properties. In some instances, the operational characteristics may include values for some of the properties that are also included in the historical characteristics. In still yet other instances, the operational characteristics may include values for some properties that are not included in the historical characteristics.

External information corresponding to the fracking devices that transmits operational characteristics may be received. In some instances, external information for a particular fracking device may be received the first time the fracking device transmits operational characteristics to the server. It may not be necessary to transmit the external information for that fracking device again until the external information changes. The fracking device may generate a delta that includes only the new or updated information and transmit the delta to the server to reduce the size of the transmission to the server. In some instances, external information may also be received from other sources such as, but not limited to, one or more servers, an operator of the fracking devices via a mobile terminal, a manufacturer of the fracking devices, combinations thereof, and the like.

At block 620, the received operational characteristics for each fracking device may be input into the trained machine-learning model to generate a service object. The service may include a single value indicating an amount of remaining operational life for each fracking devices. For example, the value can be an integer indicating an amount of remaining minutes, hours, days, months, or years remaining. The value may be a percentage of a remaining operational life such as when the maximum life may be known. The service object may also include one or more properties included within the operational characteristics, one or more portions of the external information, a maintenance schedule, root cause of each reported or detected failure, an amount of operational life for one or more components of the fracking device, combinations thereof, or the like. The maintenance schedule may indicate a time in which the fracking device is to be analyzed, calibrated, repaired, replaced, or the like. If the service object for a particular fracking device already exits, the existing service object may be updated or replaced such that the resulting service object includes new output from the trained machine-learning model.

At block 624, a communication may be received from a remote device requesting the status of one or more fracking devices. The request may indicate a particular fracking device, a particular component of the fracking device, one or more portions of operational characteristics associated with the fracking device, a particular properties associated with the device, a geographical location, a time interval over which data was collected, combinations thereof, or the like. For example, the communication may request the values of all properties corresponding to a particular fracking device type located at a particular drill site. A set of services objects, each corresponding to fracking devices of the requested fracking devices type that is located at the drill site, may be packaged for transmission to the remote device.

At block 628, the one or more service objects that satisfy the request may be packaged and transmitted to the remote device. In some instances, only a representation of the service objects may be transmitted to the remote device. For example, a graphical user interface that includes a representation of each service object to be transmitted to the remote device may be generated. The graphical user interface may be transmitted to the remote device. In some instances, such as when, the communication may request data for a continuous time interval, a data stream may be generated to stream the requested service objects in real-time to the remote device until the expiration of the time interval.

Once the request is satisfied, the process may terminate. Alternatively, the process may (1) return to block 604 in which new data may be used to generate new feature sets for training a new machine-learning model or retraining the current machine-learning model, (2) return to block-616 in which new operational characteristics may be received and the corresponding service objects may be updated, or (3) return to block 624 in which a new request for one or more portions of operational characteristics may be received and processed.

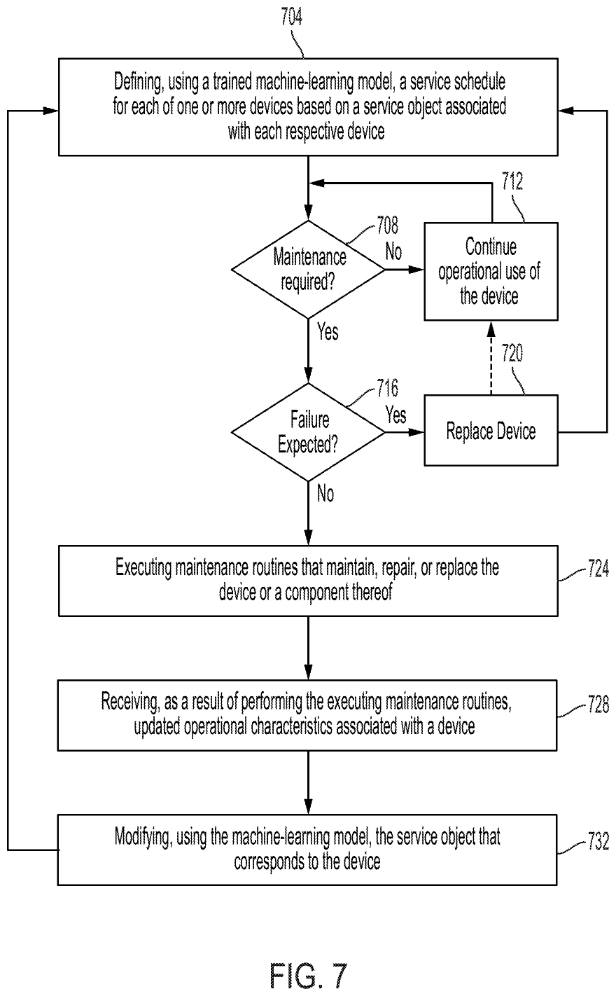

FIG. 7 is a flowchart of a process for maintaining fracking devices in the field using a trained machine-learning model according to one aspect of the present disclosure. At block 704, a service schedule can be defined for one or more fracking devices in-use in fracking operations. The service schedule may use a machine-learning model that was trained using historical operational characteristics and external information received from similar fracking devices, other fracking devices of the same type, or the particular fracking device. Once trained the machine-learning model may be used to determine when a particular fracking device of the one or more fracking devices may be taken offline for repairs or replacement such that an impact on the field operations may be minimized. For example, if the fracking device remains in-use until it fails, the fracking operations may shutdown until a new device can be sourced and brought online. The machine-learning model identifies potential points of failure and defines the service schedule to prevent such failures or otherwise minimize the impact on the fracking operations by, using the example above, ensuring that particular replacement fracking device or components are available.

At block 708, it is determined if the fracking device requires maintenance based on the service schedule of the fracking device. The service schedule may indicate that maintenance required at set time intervals such as a particular date and time, at the expiration of a time interval such as every 30 days, based on the operating conditions of the fracking device, combinations thereof, or the like. For example, if a particular fracking device is used under routine conditions, then the service schedule may indicate that maintenance is required at a particular date and time or expiration of the time interval. On the other hand, if the fracking device is operated outside of routine conditions, the service schedule may trigger a maintenance-required indication outside of the regular schedule at a date or time determined based the particular conditions under which the fracking device is operating. For example, maintenance required may be indicated if a failure is expected in the fracking device or component thereof due to the non-routine operating conditions.

If the fracking device does not require maintenance then the process continues at block 712 in which the fracking devices resumes operations. If maintenance is required, the process continues at block 716 in which it is determined whether the maintenance required indication was triggered by an expected failure in the fracking device. The expected failure may be based an assessment by the trained machine-learning model that processed real-time operating characteristics of the fracking device. If a failure in the fracking device is detected then the process may continue at block 720 in which the fracking device or a component thereof may be replaced to restore the functionality provided by the fracking device. In some instance, once the fracking device, or a component thereof, is replaced, the process may return to block 704 in which the trained machine-learning model may generate a new service schedule for the fracking device. In other instances, replacing a component of the fracking device may not necessitate generating a new service schedule. Instead, in those instances, the process may return to block 712 in which operational use of the fracking device may be resumed.

At block 724, when it is determined that maintenance is required, one or more maintenance routines may be executed on the fracking device. The maintenance routines may be executed by an automated drone, an operator, or by executing one or more software instructions. The maintenance routines can include, but are not limited to: repair of the fracking device or component; replacement of a component of the fracking device; replacement of the fracking device; inspection for wear or damage; testing the fracking device or components thereof; replacement or replenishment of fluids such as lubricant, antifreeze, water, etc.; refiling reservoirs such as fuel, diverter, proppant, etc.; updating or repairing software executing on the fracking device, updating or upgrading the fracking device or a component thereof, combinations thereof, or the like.

At block 728, updated operational characteristics of the fracking device may be received as a result of executing the maintenance routines. The operational characteristics may additionally include a report of the maintenance such as a timestamp of the maintenance, a duration, type of maintenance executed, success or failure of the maintenance, combinations thereof, or the like. At block 732, the operational characteristics and maintenance report may be used to modify the service object associated with the fracking device. The service object may continue to store real-time operational characteristics with an indication that maintenance was performed to separate the operational characteristics received prior to the maintenance routines from the operational characteristics received after the maintenance.

Upon modifying the service object to include the updated operational characteristics and maintenance report, the process may return to block 704 in which the trained machine-learning model may generate a new service schedule for the fracking device based on the modified service object. For example, some fracking devices may require maintenance more frequently as the fracking devices remain in operational use. Replacing one or more components of a fracking device may return the fracking device to a state requiring less frequent maintenance. The trained machine-learning model may use the modified service object to revise the service schedule or generate a new service schedule for the fracking device. In some instances, blocks 704-732 can represent a continuous process that does not terminate as long as at least one fracking device is in operational use. In some instances, blocks 704-732 may be executed in-order, out-of-order, each block may be executed once before the process continues to another block, or each block may be executed more than once before the process continues.

While the principles of the disclosure have been described above in connection with specific apparatuses and methods, it is to be clearly understood that this description is made only by way of example and not as limitation on the scope of the disclosure.

What is claimed is:

1. A system comprising:
one or more processors;
one or more memories connected to the one or more processors for storing instructions that are executable by the one or more processors to cause the one or more processors to perform operations including:
receiving, from each fracking device of one or more fracking devices, historical characteristics corresponding to usage of a corresponding fracking device;
defining a feature set for each fracking device of the one or more fracking devices using the historical characteristics, the feature set including a device type and a portion of the historical characteristics of the corresponding fracking device;
generating a trained machine-learning model using the feature set corresponding to each fracking device of the one or more fracking devices;
receiving, from each fracking device of the one or more fracking devices, operational characteristics;
generating, using the trained machine-learning model and the operational characteristics, a service object for each fracking device of the one or more fracking devices, wherein the service object indicates an expected operational life of the fracking device and an amount of time remaining until a failure is expected to occur;
receiving, from a remote computing device, a request for a portion of operational characteristics associated with a particular fracking device of the one or more fracking devices; and
transmitting, to the remote computing device, a representation of the service object corresponding to the particular fracking device in response to receiving the request, the representation of the service object for use to determine an interval of time over which to initiate or cease a wellbore operation.

2. The system of claim 1, wherein an internet-of-things device is coupled to with each fracking device of the one or more fracking device, the internet-of-things device acting as a network interface for the fracking device.

3. The system of claim 1, wherein the operational characteristics are adapted to be streamed over a time period of a predetermined duration.

4. The system of claim 1, the operations further including:
generating graphical user interface using the operations characteristics for at least one fracking device of the one or more fracking devices; and
displaying the graphical user interface on a display device.

5. The system of claim 1, wherein the service object is adapted to indicate a root cause of the failure.

6. The system of claim 1, the operations further including:
generating, using the trained machine-learning model and the service object, a maintenance schedule for each fracking device of the one or more fracking devices, the maintenance schedule indicating a particular time in which each fracking device is to be taken offline, repaired, or replaced, wherein the particular time occurs prior to the failure is expected to occur.

7. The system of claim 1, the operations further including:
detecting, by the trained machine-learning model, that the failure is expected to occur in a first fracking device of the one or more fracking devices within a threshold duration of time;
transmitting a communication to a client device associated with the first fracking device, the communication indicating that the failure is expected to occur and a particular component of the first fracking device that is a root cause of the failure; and
replacing the particular component of the first fracking device to prevent the failure.

8. A method comprising:
receiving, from each fracking device of one or more fracking devices, historical characteristics corresponding to usage of a corresponding fracking device;
defining a feature set for each fracking device of the one or more fracking devices using the historical characteristics, the feature set including a device type and a portion of the historical characteristics of the corresponding fracking device;
generating a trained machine-learning model using the feature set corresponding to each fracking device of the one or more fracking devices;
receiving, from each fracking device of the one or more fracking devices, operational characteristics;
generating, using the trained machine-learning model and the operational characteristics, a service object for each fracking device of the one or more fracking devices, wherein the service object indicates an expected operational life of the fracking device and an amount of time remaining until a failure is expected to occur;
receiving, from a remote computing device, a request for a portion of operational characteristics associated with a particular fracking device of the one or more fracking devices; and
transmitting, to the remote computing device, a representation of the service object corresponding to the particular fracking device in response to receiving the request, the representation of the service object for use to determine an interval of time over which to initiate or cease a wellbore operation.

9. The method of claim 8, wherein an internet-of-things device is coupled to with each fracking device of the one or more fracking device, the internet-of-things device acting as a network interface for the fracking device.

10. The method of claim 8, wherein the operational characteristics are streamed over a time period of a predetermined duration.

11. The method of claim 8, further comprising:
generating graphical user interface using the operational characteristics for at least one fracking device of the one or more fracking devices; and
displaying the graphical user interface on a display device.

12. The method of claim 8, wherein the service object indicates a root cause of the failure.

13. The method of claim 8, further comprising:
generating, using the trained machine-learning model and the service object, a maintenance schedule for each fracking device of the one or more fracking devices, the maintenance schedule indicating a particular time in which each fracking device is to be taken offline, repaired, or replaced, wherein the particular time occurs prior to a time in which the failure is expected to occur.

14. The method of claim 8, further comprising:
detecting, by the trained machine-learning model, that the failure is expected to occur in a first fracking device of the one or more fracking devices within a threshold duration of time;
transmitting a communication to a client device associated with the first fracking device, the communication indicating that the failure is expected to occur and a particular component of the first fracking device that is a root cause of the failure; and
replacing the particular component of the first fracking device to prevent the failure.

15. A non-transitory computer-readable medium including instructions that are executable by one or more processors to cause the one or more processors to preform operations including:
receiving, from each fracking device of one or more fracking devices, historical characteristics corresponding to usage of a corresponding fracking device;
defining a feature set for each fracking device of the one or more fracking devices using the historical characteristics, the feature set including a device type and a portion of the historical characteristics of the corresponding fracking device;
generating a trained machine-learning model using the feature set corresponding to each fracking device of the one or more fracking devices;
receiving, from each fracking device of the one or more fracking devices, operational characteristics;
generating, using the trained machine-learning model and the operational characteristics, a service object for each fracking device of the one or more fracking devices, wherein the service object indicates an expected operational life of the fracking device and an amount of time remaining until a failure is expected to occur;
receiving, from a remote computing device, a request for a portion of operational characteristics associated with a particular fracking device of the one or more fracking devices; and
transmitting, to the remote computing device, a representation of the service object corresponding to the particular fracking device in response to receiving the request, the representation of the service object for use to determine an interval of time over which to initiate or cease a wellbore operation.

16. The non-transitory computer-readable medium of claim 15, wherein an internet-of-things device is coupled to with each fracking device of the one or more fracking device, the internet-of-things device acting as a network interface for the fracking device.

17. The non-transitory computer-readable medium of claim 15, the operations further including:
generating graphical user interface using the operations characteristics for at least one fracking device of the one or more fracking devices; and
displaying the graphical user interface on a display device.

18. The non-transitory computer-readable medium of claim 15, wherein the service object indicates a root cause of the failure.

19. The non-transitory computer-readable medium of claim 15, the operations further including:
generating, using the trained machine-learning model and the service object, a maintenance schedule for each fracking device of the one or more fracking devices, the maintenance schedule indicating a particular time in which each fracking device is to be taken offline, repaired, or replaced, wherein the particular time occurs prior to the failure is expected to occur.

20. The non-transitory computer-readable medium of claim 15, the operations further including:
detecting, by the trained machine-learning model, that the failure is expected to occur in a first fracking device of the one or more fracking devices within a threshold duration of time;
transmitting a communication to a client device associated with the first fracking device, the communication indicating that the failure is expected to occur and a particular component of the first fracking device that is a root cause of the failure; and
replacing the particular component of the first fracking device to prevent the failure.
